(19) United States
(12) Patent Application Publication
(10) Pub. No.: US 2025/0196434 A1
(43) Pub. Date: Jun. 19, 2025

(54) POWDER FOR USE IN A LAYERWISE PROCESS WITH LASERS IN THE VISIBLE AND NEAR-INFRARED RANGE

(71) Applicant: Evonik Operations GmbH, Essen (DE)

(72) Inventors: Wolfgang Diekmann, Waltrop (DE); Lisa-Maria Elmer, Muenster (DE); Maik Grebe, Bochum (DE)

(73) Assignee: Evonik Operations GmbH, Essen (DE)

(21) Appl. No.: 18/846,866

(22) PCT Filed: Mar. 15, 2023
(86) PCT No.: PCT/EP2023/056568

§ 371 Date: Sep. 13, 2024

(30) Foreign Application Priority Data
Mar. 15, 2022 (EP) 22162238.4

(51) Int. Cl. B29C 64/153; B29C 64/264; B29K 105/00; B29K 505/08; B29K 507/04; B33Y 10/00; B33Y 40/10; B33Y 70/00

(52) U.S. Cl. CPC B29C 64/153; B29C 64/264; B33Y 10/00; B33Y 40/10; B33Y 70/00; B29K 2105/005; B29K 2105/251; B29K 2505/08; B29K 2507/04; B29K 2995/0094

(57) ABSTRACT

A powder can be used for additive manufacturing processes. The powder contains composite particles containing an NIR-absorbing component as core particles. This allows uniform melting of the powder. A process for manufacturing the powder includes bringing a polymer into contact with a medium having a solvent capable of dissolving the first polymer in the presence of core particles under elevated pressure and/or temperature, and subsequently precipitating the polymer out of the solution.

The present invention relates to powders for additive manufacturing processes, wherein the powder contains composite particles containing an NIR-absorbing component as core particles. This allows uniform melting of the powder.

Customary powders in SLS have poor absorption in the visible and near-infrared range. Lasers which emit radiation in this wavelength range can couple with the powder only with difficulty, if at all.

Powders are typically coated with an absorbent pigment, usually in a dryblend process. The absorber pigment is then mainly found on the surface, thus resulting in a low L* value of the powder thus produced. One alternative is incorporating the absorbent pigment into a polymer melt. The solidified melt is then and granulated and subsequently ground. The disadvantage of the prior art is that the laser mainly couples with the surface of the powder particle. The core of the particle is therefore not directly melted by the laser but rather only via thermal conduction from the strongly heated outer layer of the particle. As a result the cores of the particles are only partially melted, if at all, and act as crystallization seeds which bring about premature solidification of the melt, which in turn results in a higher tendency for warpage of the components produced.

The rapid provision of prototypes is a problem that has often been addressed in recent times. Processes which operate on the basis of pulverulent materials and in which the desired structures can be produced in layerwise fashion by selective melting and solidification are particularly suitable. Supporting structures in the case of overhangs and undercuts can be dispensed with since the powder bed surrounding the molten regions provides sufficient support. The subsequent work of removing supports is likewise avoided. The processes are also suitable for production of small runs.

The selectivity of the layerwise process may be effected for example by application of susceptors, absorbers, inhibitors or via masks or via focused energy introduction such as for example via a laser beam or via glass fibres. Energy introduction is preferably achieved via electromagnetic radiation.

A process which is particularly suitable for the purpose of rapid prototyping is selective laser sintering. In this process, polymer powders are briefly selectively irradiated with a laser beam in a chamber, thus melting the powder particles struck by the laser beam. The molten particles coalesce and rapidly resolidify to form a solid mass. By repeated irradiation of a constant succession of freshly applied layers, this process can be used for rapid and simple production of three-dimensional articles.

The process of laser sintering (rapid prototyping) for the purpose of producing shaped articles from pulverulent polymers is described extensively in U.S. Pat. No. 6,136,948 and WO 96/06881. A multiplicity of polymers and copolymers are claimed for this application, such as for example polyacetate, polypropylene, polyethylene, ionomers and polyamide.

Other suitable processes are the SIV process, as described in WO 01/38061, or a process as described in EP 1 015 214. Both processes operate with a flat infrared heating means for melting the powder. The selectivity of the melting is achieved by application of an inhibitor in the former process and via a mask in the latter process. Such a process is described in DE 103 11 438. In this process the energy required for melting is introduced via a microwave generator and the selectivity achieved by application of a susceptor.

Further suitable processes include those operating with an absorber which is either present in the powder or applied by inkjet processes as described in DE 10 2004 012 682.8, DE 10 2004 012 683.6 and DE 10 2004 020 452.7.

The recited rapid prototyping or rapid manufacturing processes (RP or RM processes) can employ pulverulent substrates, in particular polymers, preferably selected from polyesters, polyvinyl chloride, polyacetal, polypropylene, polyethylene, polystyrene, polycarbonate, poly(N-methyl methacrylimides) (PMMI), polymethyl methacrylate (PMMA), ionomer, polyamide or mixtures thereof.

WO 95/11006 describes a polymer powder suitable for laser sintering which during determination of the melting behavior by differential scanning calorimetry at a scanning rate of 10° C. to 20° C./min shows no overlap of the melting and recrystallization peak, has a degree of crystallinity likewise determined by DSC of 10% to 90% and a number-average molecular weight Mn of 30 000 to 500 000 and whose Mw/Mn quotient is in the range from 1 to 5.

DE 197 47 309 describes the use of a copolyamide-12 powder having an elevated melting temperature and elevated melting enthalpy which is obtained by reprecipitation of a polyamide previously produced by ring-opening and subsequent polycondensation of laurolactam. This is a polyamide 12.

WO 2007/051691 describes processes for producing ultrafine powders based on polyamides which comprise precipitating polyamides in the presence of inorganic particles using a suspension comprising inorganic particles suspended in alcoholic medium with an average size of the inorganic particles dv₅₀ in the range from 0.001 to 0.8 μm. The objective of this process was to achieve a dyeing of the powder. Fine polyamide powders were obtained, and the inorganic particles are uniformly distributed in the composite particles on account of their small size.

DE 10 2004 003 485 describes the use of particles having at least one cavity for use in layer-building processes. All particles contain at least one cavity and the particles containing the cavity are melted by introduction of electromagnetic energy. The described powder particles have a surface layer of low thickness.

DE 102 27 224 describes a granulate for 3D binder printing which consists of particles provided with a surface layer having a nonpolar outer surface. However, the surface layer of the described powder particles has a low thickness.

In the prior art the above-described powders are sometimes mixed with other particles, for example metal particles, glass particles or TiO₂ particles, for reinforcement.

Diverging properties of the produced components that are difficult to control occur especially when the handling of the powder is automated in the rapid manufacturing.

The problem addressed by the present invention is accordingly that of providing a powder which shows good absorption in the near infrared range (NIR) and preferably also in the visible range and at the same time does not have the disadvantages of the prior art.

It has surprisingly been found that the problem can be solved by a core-shell construction of the particle. The NIR absorber is concentrated in the core of the particle. This construction of the particle has the result that the powder particles are more uniformly melted. The powder material is obtained by means of a precipitation process where in the precipitation preferably at least 0.1% of an absorber is added so that the polymer surrounds this absorber and a shell-core construction is achieved.

Accordingly the invention relates to a powder for use in a layerwise process for producing shaped articles in which regions of the respective powder layer are selectively melted by introduction of electromagnetic energy, containing composite particles which are entirely or partially composed of core particles coated with a precipitated first polymer, characterized in that the core particles contain an NIR-absorbing (near infrared-absorbing) component.

Near-infrared (NIR) according to the invention is in particular in a wavelength range from 780 to 1500 nm.

The NIR-absorbing component may have an absorption of at least 40%, preferably 45%, more preferably 50%, particularly preferably 55% and very particularly preferably 60% at all wavelengths in the range from 780 to 1500 nm. The term “at all wavelengths” relates to all integer wavelengths.

The NIR-absorbing component may have an absorption of at least 40%, preferably 45%, more preferably 50%, particularly preferably 55% and very particularly preferably 60% in the wavelength range of the electromagnetic energy of the laser from 780 to 1500 nm. The term “at all wavelengths” relates to all integer wavelengths.

The NIR-absorbing component may also have an absorption of at least 40%, preferably 45%, more preferably 50%, particularly preferably 55% and very particularly preferably 60% at the average of the wavelength in the range from 780 to 1500 nm.

The NIR-absorbing component should have an absorption of at least 40%, preferably 50%, more preferably 60%, particularly preferably 65% and very particularly preferably 70% in the wavelength range (preferably +/−10 nm) of the electromagnetic energy of the laser. The wavelength of an Nd-YAG laser is 1064 nm for example. The wavelength of an HPDL (high-power diode laser) laser is 906 nm for example. However high-power diode lasers are available in a multiplicity of wavelengths and may be used according to the invention. However it is preferable when the high-power diode lasers emit radiation having a wavelength in the NIR range. Accordingly, the NIR-absorbing component may have an absorption of at least 40%, preferably 50%, more preferably 60%, particularly preferably 65% and very particularly preferably 70% at the wavelengths 906 nm (preferably +/−10 nm) and/or 1064 nm (preferably +/−10 nm). The specific laser or the wavelength of the laser is in principle not limited. However a laser which is in the absorption range of the NIR-absorbing component should be selected.

The absorption of the NIR-absorbing component may be determined from the pure component (for example solid) using an integrating sphere. A detector in the integrating sphere is used to measure the transmitted radiation which is passed into the integrating sphere through the sample. A reference measurement without a sample serves as the calculation basis and for correction of the result. A quartz glass cuvette may be utilized as the sample carrier. The cuvette consists of two quartz glass halves, wherein one half has a cutout into which the powder may be poured. After filling the halves are closed and stood upright to compress the powder bed. The thickness of the cutout is between 0.2 and 0.5 mm (layer thickness). A suitable measuring instrument is an Agilent Cary UV-VIS-NIR 5000 instrument, wavelength range 250 nm-2500 nm.

The NIR-absorbing component may also be a VIS-und NIR-absorbing component. Visible light (VIS) according to the invention has a wavelength of 380 to 780 nm.

The NIR-absorbing component should have an absorption of at least 40%, preferably 45%, more preferably 50%, particularly preferably 55% and very particularly preferably 60% at all wavelengths in the range from 380 to 1500 nm. The NIR- and VIS-absorbing component may likewise have an absorption of at least 40%, preferably 50%, more preferably 60%, particularly preferably 65% and very particularly preferably 70% in the wavelength range (preferably +/−10 nm) of the electromagnetic energy of the laser. Accordingly, the NIR- and VIS-absorbing component should have an absorption of at least 40%, preferably 50%, more preferably 60%, particularly preferably 65% and very particularly preferably 70% at the wavelengths 906 nm (preferably +/−10 nm) and 1064 nm (preferably +/−10 nm).

The NIR- and VIS-absorbing component may have an absorption of at least 40%, preferably 45%, more preferably 50%, particularly preferably 55% and very particularly preferably 60% in the wavelength range of the electromagnetic energy of the laser from 780 to 1500 nm. The term “at all wavelengths” relates to all integer wavelengths.

It is especially preferable when the NIR-absorbing component is an inorganic particle. The NIR-absorbing component may comprise carbon black and/or TiO₂. It is particularly preferable when the NIR-absorbing component is carbon black. Carbon black absorbs not only in the NIR range but also in the VIS range, as a result of which the electromagnetic energy (or radiation) may be incorporated into the powder in a greater wavelength range. The NIR-absorbing component should be insoluble during the precipitation process.

The NIR-absorbing component may be the core particle and in particular the core particle may be carbon black. It is possible for the core particle to contain a mixture of carbon black and TiO₂.

The NIR-absorbing component should have an L* (according to CIEL*a*b*, DIN EN ISO/CIE 11664-4) of not more than 10, preferably of not more than 5, particularly preferably of not more than 3. The L* value is an indicator of the ability of a component to absorb electromagnetic energy (or radiation) in the NIR and/or VIS range. Carbon black is a suitable component having an aforementioned L* value.

The NIR-absorbing component (in particular carbon black) is ideally present in an amount of 0.01% to 7% by weight based on the total weight of the composite particle, preferably in an amount of 0.1% to 5% by weight, more preferably in an amount of 0.1% to 4% by weight, particularly preferably in an amount of 0.1% to 3% by weight and very particularly preferably in an amount of 0.2% to 2% by weight. The core-shell construction of the composite particle according to the invention has the result that the proportion of the NIR-absorbing component is substantially higher in the core of the composite particle than in the shell of the composite particle. The weight fraction of the NIR-absorbing component in the core of the composite particle is preferably 10 times, 50 times or 100 times higher based on the total weight of the NIR-absorbing component in the composite particle.

This is in particular expressed by a high L* of the composite particle. Even if the individual NIR-absorbing component has a very low L* value, the L* value of the composite particle is high. The composite particles should have an L* (according to CIEL*a*b*, DIN EN ISO/CIE 11664-4) of above 20, preferably of above 30, particularly preferably of above 50.

The NIR-absorbing component (in particular carbon black) may be present in an amount of 1% to 100% by weight based on the total weight of the core particle, preferably in an amount of 10% to 50% by weight, more preferably in an amount of 40% to 100% by weight, particularly preferably in an amount of 80% to 100% by weight and very particularly preferably in an amount of 100% by weight. The value of 100% by weight based on the total weight of the core particle means that the core particle consists of the NIR-absorbing component. However, it is possible for the core particle to consist of the NIR-absorbing component and a second polymer. The shell should ideally be free from the NIR-absorbing component.

The layerwise process for producing shaped articles is preferably selective laser sintering.

The particular core particles may be configured in the following shapes: spherical, platelet-shaped or elongate. The respective core particles may moreover be sharp-edged, rounded or smooth. The recited core particles may optionally be coated with a size before application of the first polymer to be precipitated.

The precipitated/precipitable first polymer is a polymer that is soluble in a liquid medium containing a solvent and is precipitated as completely or partially insoluble precipitate in the form of flakes, droplets or in crystalline form through changes in certain parameters such as for example temperature, pressure, content of solvent, nonsolvent, antisolvent, precipitant. The type of solvent and the content of solvent as well as the further parameters for dissolving or precipitating the relevant polymer depend on the polymer.

The precipitable/precipitated first polymer may be selected from polyolefins, polyethylene, polypropylene, polyvinyl chloride, polyacetal, polystyrene, polyimides, polysulfones, poly(N-methylmethacrylimides) (PMMI), polymethyl methacrylate (PMMA), polyvinylidene fluorides (PVDF), ionomer, polyether ketones, polyaryl ether ketones, polyamide, copolyamide or mixtures thereof, in particular mixtures of homo- and copolyamide. It is preferable when the precipitable/precipitated first polymer is a crystalline or semicrystalline polymer. It is particularly preferable when the precipitable/precipitated first polymer is a polyamide or a copolyamide.

The precipitable/precipitated first polymer should be soluble in the precipitation process, in particular soluble in the solvent used for precipitation. For example the first polymer should be soluble in ethanol in the precipitation process. Soluble is to be understood as meaning that at least 33 g/L (in particular 200 g/L) of the relevant polymer dissolves in the relevant solvent in the precipitation process, for example at 145° C. The second polymer may be selected from polycarbonate, polymethyl methacrylate, polypropylene, polybutylene terephthalate, polyethylene terephthalate, polyether ether ketone, polyphthalamide or mixtures thereof. The core particles containing a second polymer are produced by milling for example.

The second polymer should be insoluble in the precipitation process, in particular insoluble in the solvent used for precipitation. For example the first polymer should be insoluble in ethanol in the precipitation process. Insoluble is to be understood as meaning that not more than 10 g/L (in particular 1 g/L) of the relevant polymer dissolves in the relevant solvent in the precipitation process, for example at 145° C.

The particles used for coating with the precipitated first polymer preferably contain a second polymer. In contrast to polymer powders that are merely mixed with other particles or NIR-absorbing components (dry-blend) the powders according to the present invention no longer exhibit any demixing.

The powder according to the invention preferably has a core-shell construction. The second polymer of the core particle may be any known polymer provided that the second polymer is insoluble or substantially insoluble in the solvent in which the precipitable first polymer is dissolved. The second polymer is thus different from the (precipitated/precipitable) first polymer. The second polymer differs from the (precipitated/precipitable) first polymer at least in terms of its solution properties in a particular solvent which dissolves the first polymer.

The precipitated first polymer for coating the core particle may be obtained by precipitation of at least one polyamide of the AABB type or by joint precipitation of at least one polyamide of the AB type and at least one polyamide of the AABB type. Preference is given to coprecipitated polyamides, wherein at least polyamide 11 or polyamide 12 and at least one polyamide based on PA1010, PA1012, PA1212, PA613, PA106 or PA1013 is present.

The following precipitable polymers may be mentioned for example: polyolefins and polyethylene are soluble in toluene, xylene or 1,2,4-trichlorobenzene for example. Polypropylene is soluble in toluene or xylene for example. Polyvinyl chloride is soluble in acetone for example. Polyacetal is soluble in DMF, DMAc and NMP for example. Polystyrene is soluble in toluene for example. Polyimides are soluble in NMP for example. Polysulfones are soluble in sulfolane for example. Poly(N-methyl methacrylimides) (PMMI) are soluble in DMAc or NMP for example. Polymethyl methacrylate (PMMA) is soluble in acetone for example. Polyvinylidene fluorides are dissolvable in N-methylpyrrolidone (NMP), dimethylformamide (DMF), dimethylacetamide (DMAc) or cyclohexanone. Polyether ketones and polyarylene ketones are soluble in diphenylsulfone or in sulfolane. Polyamides are soluble in an alcoholic medium, preferably an ethanol-water mixture. As elucidated above it may also be necessary to adjust parameters such as for example temperature and pressure to dissolve a particular polymer.

After dissolution of the particular (first) polymer this is precipitated in the presence of the core particles to completely or partially coat these core particles with the particular precipitated first polymer. As recited above, a second polymer and/or the NIR-absorbent component are selected as the core particle which is insoluble or substantially insoluble under the conditions in which the first polymer is dissolved. The precipitation of the first polymer may be initiated/accelerated by altering the pressure, altering the temperature, altering (reducing) the concentration of the solvent and optionally adding a nonsolvent, antisolvent or precipitant. Amorphous polymers, such as polystyrene, polysulfones, PMMI, PMMA, ionomer, require addition of a nonsolvent for precipitation of the particular polymer.

The precipitable first polymer is preferably a polyamide which comprises at least 8 carbon atoms per carbonamide group. It is particularly preferable when the polymer is a polyamide which comprises 10 or more carbon atoms per carbonamide group. It is very particularly preferable when the polymer is a polyamide selected from polyamide 612 (PA 612), polyamide 11 (PA 11) and polyamide 12 (PA 12). The process for producing the polyamides employable in the sinter powder according to the invention is common knowledge and for the production of PA 12 for example may be found in the specifications DE 29 06 647, DE 35 10 687, DE 35 10 691 and DE 44 21 454. The required copolyamide is obtainable from various producers, for example polyamide 12 granulate is obtainable from Evonik Industries AG under the trade name VESTAMID.

It is particularly preferable when the precipitated/precipitable polymer is polyamide 12.

It is also possible to employ the corresponding copolyamides or mixtures of homo- and copolyamides which contain at least 70% by weight of the recited units. As comonomers they may accordingly contain 0% to 30% by weight of one or more comonomers, such as caprolactam, hexamethylenediamine, 2-methylpentane-1,5-diamine, octamethylene-1,8-diamine, dodecamethylenediamine, isophoronediamine, trimethylhexamethylenediamine, adipic acid, suberic acid, azelaic acid, sebacic acid, dodecanedioic acid, aminoundecanoic acid. The recited homo- and copolyamides referred to hereinbelow as polyamide are employed as granulates or pellets having a relative solution viscosity between 1.5 and 2.0 (measured in 0.5% m-cresol solution at 25° C. according to DIN 53 727), preferably between 1.70 and 1.95. They may be produced by polycondensation, hydrolytic or acidolytic/activated anionic polymerization according to known processes. It is preferable to employ balanced polyamides having NH₂/COOH end group ratios of 40/60 to 60/40. However, it is advantageously also possible to employ unbalanced polyamides, preferably ones where the NH₂/COOH end group ratio is between 90:10 and 80:20 or 10:90 and 20:80.

The core particles may have an average particle diameter dv₅₀ of 1 μm or more. In particular the core particles have a size of 1 μm or more in all three spatial directions.

Furthermore, the core particles may have an average particle diameter dv₅₀ of 1 to 100 μm, preferably of 10 to 80 μm, preferably of 10 to 70 μm, more preferably of 10 to 60 μm, more preferably of 10 to 50 μm, particularly preferably of 10 to 40 μm.

Suitable particle size distributions may be ensured via known processes, for example sieving, sifting.

It is further preferable when the composite particles have an average particle diameter dv₅₀ of 20 to 150 μm, preferably of 20 to 120 μm, preferably of 20 to 100 μm, more preferably of 25 to 80 μm and particularly preferably of 25 to 70 μm.

In a preferred process of the coating of the precipitated polymer has a thickness of 1.5 μm or more, preferably 2, 3, 5, 10, 15, 20, 25, 30 μm or more.

The weight-based ratio of the polymer to the core particles based on the entirety of the composite particles is preferably from 0.1 to 30, preferably from 1.0 to 20.0 and more preferably from 1.3 to 10.0.

The ratio of the average particle diameter dv₅₀ of the composite particles to the average core diameter dv₅₀ of the core particles may be from 1.5 to 30, preferably from 1.5 to 25, more preferably 1.5 to 15, yet more preferably 1.5 to 12 and particularly preferably 1.5 to 10.

The powder according to the invention may have a BET specific surface area in the range of 2-35 m²/g, preferably 2-15 m²/g, particularly preferably of 3-12 m²/g and very particularly preferably of 3-10 m²/g. The powder according to the invention may further have a poured density PD in the range from 200 too 600 g/l, preferably from 200 to 500 g/l.

The density of the core particles may be greater than or not more than 20%, preferably not more than 15%, more preferably not more than 10% and particularly preferably not more than 5%, lower than the density of the solvent used for the precipitation of the first polymer.

In the precipitation of the first polymer in the presence of the core particles it is particularly preferable to employ an alkanol (for example: methanol, ethanol, propanol, butanol), preferably ethanol, as the solvent, wherein the density of the core particles is more than or not more than 20%, preferably not more than 15%, more preferably not more than 10% and particularly preferably not more than 5% lower than the density of the alkanol, preferably of ethanol.

The powder may contain the recited composite particles alone or together with further fillers and/or auxiliaries incorporated in free-flowing form (dry blend). The proportion of the composite particles in the powder is at least 50% by weight, preferably at least 80% by weight, preferably at least 90% by weight, particularly preferably at least 95% by weight and very particularly preferably at least 99% by weight.

The powder according to the invention may further comprise auxiliaries and/or further organic or inorganic pigments. Such auxiliaries may be for example anticaking agents such as for example precipitated and/or pyrogenic silicas. Precipitated silicas are marketed with different specifications for example by Evonik Industries AG of the product name under the product name AEROSIL®. It is preferable when the powder according to the invention comprises less than 3% by weight, preferably from 0.001% 2% by weight and very particularly preferably from 0.025% to 1% by weight of such auxiliaries based on the sum of the polymers present. The pigments may for example be titanium dioxide particles based on rutile (preferred) or anatase or carbon black particles.

To improve processability or for further modification of the powder according to the invention said powder may be admixed with inorganic extraneous pigments, for example transition metal oxides, stabilizers, for example phenols, in particular sterically hindered phenols, flow control and anticaking auxiliaries, for example pyrogenic silicas. The amount of these substances added to the polymers based on the total weight of polymers in the polymer powder is preferably such that the concentrations for auxiliaries indicated for the powder according to the invention are observed.

Optimal properties in further processing of the powder are achieved when the melting point of the first polymer in the first heating is greater than in the second heating measured by differential scanning calorimetry (DSC) and when the melting enthalpy of the first polymer in the first heating is at least 50% greater than in the second heating measured by differential scanning calorimetry (DSC). The polymer of the shell of the composite particles (the first polymer) has a higher crystallinity compared to powders producible by other processes through coprecipitation of a dissolved polymer with the particles. Especially suitable for the sintering is a polyamide 12 having a melting temperature of 185° C. to 189° C., preferably of 186° C. to 188° C., a melting enthalpy of 112+/−17 KJ/mol, preferably of 100 to 125 KJ/mol and a solidification temperature of 138° C. to 143° C., preferably of 140° C. to 142° C.

The invention also provides a process for producing powders according to the present invention, wherein in order to produce an at least partial solution a polymer is brought into contact with a medium containing solvent capable of dissolving the first polymer in the presence of core particles under elevated pressure and/or temperature and subsequently the first polymer is precipitated out of the at least partial solution to obtain composite particles comprising core particles completely or partially coated with a precipitated first polymer, characterized in that the core particles contain an NIR-absorbing component.

In a preferred process the core particles (core of the composite particle) have an average particle diameter dv₅₀ of 1 μm or more, preferably 1 to 100 μm, preferably of 10 to 80 μm, preferably of 10 to 70 μm, preferably of 10 to 60 μm, more preferably up of 10 to 50 μm, particularly preferably of 10 to 40 μm. Suitable particle size distributions may be ensured via known processes, for example sieving, sifting.

The use of polymeric core particles present in the suspension in the solvent for the precipitable first polymer is of particular importance. In a preferred process variant the process of the invention has the feature that a suspension of polymeric core particles suspended in alcoholic medium is employed, wherein the core particles have the aforementioned average particle size (dv₅₀).

The composite particles produced by the production process preferably have an average particle diameter dv₅₀ of 20 to 150 μm, preferably of 20 to 120 μm, preferably of 20 to 100 μm, more preferably of 25 to 80 μm and particularly preferably of 25 to 70 μm.

It is an advantage of the process according to the invention that a step is omitted in the production of the polymer because mixing of polymer particles and auxiliary/filler particles in a dry blend is no longer necessary.

Depending on their constitution these core particles may be solid spheres, hollow spheres, porous spheres. The particular core particles may be configured in the following shapes: spherical, platelet-shaped or elongate. The respective core particles may moreover be sharp-edged, rounded or smooth. The recited core particles may optionally be coated with a size before application of the precipitated first polymer.

The precipitable first polymer is preferably selected from polyolefins, polyethylene, polypropylene, polyvinyl chloride, polyacetal, polystyrene, polyimides, polysulfones, poly(N-methylmethacrylimides) (PMMI), polymethyl methacrylate (PMMA), polyvinylidene fluorides (PVDF), ionomer, polyether ketones, polyaryl ether ketones, polyamide, copolyamide or mixtures thereof, in particular mixtures of homo- and copolyamide.

The first polymer for coating the core particle may be obtained by precipitation of at least one polyamide of the AABB type or by joint precipitation of at least one polyamide of the AB type and at least one polyamide of the AABB type. Preference is given to coprecipitated polyamides, wherein at least polyamide 11 or polyamide 12 and at least one polyamide based on PA1010, PA1012, PA1212 or PA1013 is present.

The type of solvent and the content of solvent as well as the further parameters for dissolving and reprecipitating the relevant polymer depend on the polymer and have already been elucidated hereinabove.

The following elucidations relate to precipitable first polymers which are dissolvable in alcoholic medium, in particular polyamides. For coating core particles with polymers for which other solvents are or must be used the parameters and solvents must be adapted accordingly.

The process of the invention preferably has the feature that it employs a suspension obtainable by suspending the core particles in a medium containing the solvent capable of dissolving the precipitable first polymer, for example an alcoholic medium, through introduction of an energy input of more than 1000 KJ/m³. This generally results in very useful suspensions of the core particles in the medium. The specified energy input is achievable using known apparatuses. Suitable apparatuses include: planetary kneaders, rotor-stator machines, stirrer ball mills, roller mills and the like.

The suspensions useful for the invention are produced in a medium containing solvent capable of dissolving the precipitable first polymer, for example an alcoholic medium. In the case of an alcoholic medium this may be a pure alcohol, a mixture of two or more alcohols or else alcohols having a content of water or other substances which substantially do not adversely affect the desired reprecipitation of the polyamides. The alcoholic medium of the suspensions preferably has a content of less than 50% by weight of nonalcoholic substances (preferably water), particularly preferably less than 30% by weight and particularly advantageously less than 10% by weight of foreign nonalcoholic substances. Generally suitable for the invention are all types of alcohols or mixtures thereof which permit re-precipitation of polymers, preferably polyamides, under the desired conditions (pressure and temperature). In individual cases it is possible for a person skilled in the art to adapt the system to specific requirements without a great deal of effort. The process of the invention preferably employs as the alcoholic medium for the re-precipitation of the polyamide and/or the suspension of the core particles one or more alcohols having a ratio of oxygen atom to carbon atoms in the range from 1:1 to 1:5.

Typical alcohols for producing the suspension of the core particles are those having a ratio of oxygen to carbon of 1:1, 1:2, 1:3, 1:4 and 1:5, preferably those having an oxygen to carbon ratio of 1:2 and 1:3, particularly preferably having an oxygen to carbon ratio of 1:2. It is very particularly advantageous to employ ethanol in the production of a suspension of the core particles and in the reprecipitation of the precipitable polymer, preferably the polyamides.

As elucidated above the precipitable first polymer is preferably selected from polyolefins, polyethylene, polypropylene, polyvinyl chloride, polyacetal, polystyrene, polyimides, polysulfones, poly(N-methylmethacrylimides) (PMMI), polymethyl methacrylate (PMMA), polyvinylidene fluorides (PVDF), ionomer, polyether ketones, polyaryl ether ketones, polyamide, copolyamide or mixtures thereof, in particular mixtures of homo- and copolyamide. The precipitable polyamide is dissolved in an appropriate solvent to coat the core particles by reprecipitation on the surface thereof.

The employed reprecipitable polymers are preferably polyamides. The precipitable polymer is preferably a polyamide which comprises at least 8 carbon atoms per carbonamide group. It is particularly preferable when the polymer is a polyamide which comprises 10 or more carbon atoms per carbonamide group. Preferred polyamides employable as starting material for the process of the invention comprise inter alia polyamide 11, polyamide 12 and polyamides having more than 12 aliphatically bonded carbon atoms per carbonamide group, preferably polyamide 11 or polyamide 12, preferably polyamide 12. It is also possible to employ the corresponding copolyamides or mixtures of homo- and copolyamides which contain at least 70% by weight of the recited units. As comonomers they may accordingly contain 0% to 30% by weight of one or more comonomers, such as caprolactam, hexamethylenediamine, 2-methylpentane-1,5-diamine, octamethylene-1,8-diamine, dodecamethylenediamine, isophoronediamine, trimethylhexamethylenediamine, adipic acid, suberic acid, azelaic acid, sebacic acid, dodecanedioic acid, aminoundecanoic acid. The recited homo- and copolyamides referred to hereinbelow as polyamide are employed as granulates or pellets having a relative solution viscosity between 1.5 and 2.0 (measured in 0.5% m-cresol solution at 25° C. according to DIN 53 727), preferably between 1.70 and 1.95. They may be produced by polycondensation, hydrolytic or acidolytic/activated anionic polymerization according to known processes. It is preferable to employ balanced polyamides having NH₂/COOH end group ratios of 40/60 to 60/40. The employed polyamide may contain a maximum of 0.2% by weight of H₃PO₄. It is preferable to employ polyamide free from H₃PO₄. However, it is advantageously also possible to employ unbalanced polyamides, preferably ones where the NH₂/COOH end group ratio is between 90:10 and 80:20 or 10:90 and 20:80.

The solution of the precipitable first polymers, preferably the polyamides, for reprecipitation may be produced by all known methods. An ideally complete solution of the precipitable polymers, preferably of the polyamide, in the relevant medium, preferably an alcoholic medium, in the presence of the core particles suspended therein is advantageous. The solution may be brought about by application of pressure and/or temperature. It is advantageous when the precipitable polymer, preferably the polyamide, is initially charged in the alcoholic medium and dissolved over the necessary time period by application of elevated temperature. The suspension of the core particles may be added before, during or after dissolution of the precipitable polymer, preferably the polyamide. The suspension of the core particles is advantageously initially charged together with the precipitable polymer, preferably with the polyamide. The dissolving operation is advantageously supported by the use of adapted stirring apparatuses. The precipitation of the precipitable polymer, preferably of the polyamide, can likewise be supported by application of pressure and/or temperature. Thus for example a reduction in the temperature and/or distillative removal (preferably under reduced pressure) of the solvent, i.e. of the alcoholic medium, preferably result in precipitation of the precipitable polymer, preferably of the polyamide. However, it is also possible to support the precipitation by addition of an antisolvent (precipitant).

After formation of the composite particles the process can additionally comprise an aftertreatment of the composite particles in a high-shear mixer. The temperature is particularly preferably above the glass transition temperature of the particular polymer. These measures serve to round off the particles and improve flowability.

The abovementioned parameters are determined as follows:

BET surface area was determined according to DIN ISO 9277 2003-05 with a gas adsorption unit from Micromeritics to determine the specific surface area after the BET process (Micromeritics TriStar 3000 V6.03: V6.03 refers to the software version of the software Win3000). The BET surface area was determined by gas adsorption of nitrogen by the discontinuous volumetric method (DIN ISO 9277:2003-05, chapter 6.3.1.). To this end a plurality (seven) measured points were determined at relative pressures P/P0 between 0.05 and 0.20. Calibration of the dead volume was carried out using He (purity at least 4.6 [99.996%] according to the operating instructions or at least 4.0 [99.99%] according to the standard; this also applies to N2). The samples were degassed in each case for 1 hour at room temperature (21° C.) and 16 hours at 80° C. under vacuum. The specific surface area was based on the degassed sample. Evaluation was carried out by multipoint determination (DIN ISO 9277:2003-05, chapter 7.2). The temperature during measurement was 77 K.

Particle size (fineness dv₅₀) was determined by laser diffraction. Measurements were made with a Malvern Mastersizer 2000. This is a dry measurement. For the measurement in each case 20-40 g of powder are added using a Scirocco dry dispersion instrument. The vibratory conveyor chute was operated at a feed rate of 70%. The dispersing air pressure was 3 bar. A background measurement was carried out for each measurement (10 seconds/10 000 individual measurements). The sample measurement time was 5 seconds (5000 individual measurements). The refractive index and the blue light value were specified to 1.52. Mie theory was used for evaluation. The particle size distribution is a volume-weighted distribution.

The poured density is determined according to DIN EN ISO 60.

Particle content is determined by an ash/combustion residue determination according to DIN EN ISO 3451 part 1 and part 4.

A determination of solution viscosity was carried out in 0.5% meta-cresol solution according to ISO 307.

Determination of the L* value (CIEL*a*b*) is carried out according to DIN EN ISO/CIE 11664-4 with an x-rite Color i7 spectrophotometer.

The present invention also provides processes for producing shaped articles by a layerwise process, where selectively regions of the respective powder layer are melted through introduction of electromagnetic energy, wherein selectivity is achieved through application of susceptors, inhibitors, absorbers or via masks, wherein a powder according to the invention is used, in particular a powder containing composite particles which are core particles entirely or partially coated with a precipitated polymer according to the invention, wherein the wavelength of the electromagnetic energy is in the near-infrared range in a wavelength range of 780 to 1500 nm.

The present invention also provides shaped articles obtained from the powder according to the invention by the abovementioned process. The shaped article thus produced contains a polymer/polymers preferably selected from polyolefins, polyethylene, polypropylene, polyvinyl chloride, polyacetal, polystyrene, polyimides, polysulfones, poly(N-methylmethacrylimides) (PMMI), polymethyl methacrylate (PMMA), polyvinylidene fluorides (PVDF), ionomer, polyether ketones, polyaryl ether ketones, polyamide, copolyamide or mixtures thereof, in particular mixtures of homo- and copolyamide. In a further embodiment the polymer is at least one polyamide of the AABB type or a mixture of at least one polyamide of the AB type and at least one polyamide of the AABB type. Preference is given to mixtures of polamides, wherein at least polyamide 11 or polyamide 12 and at least one polyamide based on PA1010, PA1012, PA1212, PA613, PA106 or PA1013 is present.

Advantages in the case of this powder or process and/or when using the powder according to the invention derive from the fact that the powder melts uniformly and at the same time a powder that is easy to dye is obtained. In addition the NIR-absorbing component does not undergo demixing, fewer cavities form in the component, a better ecyclability is achieved, the components have a high density and a more uniform quality, sharp separation between molten and unmolten regions is achieved and the components exhibit little warpage.

Energy is introduced via electromagnetic radiation and selectivity is introduced for example via masks, application of inhibitors, absorbers, susceptors or else through focusing the radiation, for example through lasers. It is particularly preferable when the selectivity of the layerwise process is achieved via focused energy introduction. The electromagnetic radiation encompasses the range from 100 nm to 10 cm, preferably between 380 nm to 10,600 nm or between 780 and 1500 nm. The source of the radiation may for example be microwave generator, a suitable laser, a fibre laser, a heating laser or a lamp, or else a combination thereof. After cooling of all layers the shaped article may be removed.

The following examples for such processes are for elucidation without any intention to limit the invention thereto.

Laser sintering processes are well known and are based on selective sintering of polymer particles, wherein layers of polymer particles are briefly exposed to laser light and the polymer particles exposed to the laser light are thus joined to one another. Successive sintering of layers of polymer particles produces three-dimensional objects. Particulars of the process of selective laser sintering may be found for example in U.S. Pat. No. 6,136,948 and WO 96/06881.

Other suitable processes are the SIV process, such as described in WO 01/38061, or a process such as described in EP 1 015 214. Both processes operate with a flat infrared heating means for melting the powder.

The selectivity of the melting is achieved by application of an inhibitor in the former process and via a mask in the latter process. Such a process is described in DE 103 11 438. In this process the energy required for melting is introduced via a microwave generator and the selectivity achieved by application of a susceptor.

Further suitable processes include those operating with an absorber which is either present in the powder or applied by inkjet processes as described in DE 10 2004 012 682.8, DE 10 2004 012 683.6 and DE 10 2004 020 452.7.

The shaped articles produced by a layerwise process where regions are melted selectively have the feature that they comprise at least one polymer and a polymeric reinforcer and that the density of the composite component relative to a component produced from composite powder according to the prior art is reduced. Furthermore, the tendency for warpage is reduced and an improvement in the reproducibility of the mechanical properties in the shaped article is achieved.

The shaped articles may moreover comprise auxiliaries (the foregoing relating to the polymer powder applies equally) such as for example heat stabilizers, for example sterically hindered phenol derivatives. It is preferable when the shaped articles comprise less than 3% by weight, particularly preferably from 0.001% to 2% by weight and very particularly preferably from 0.05% to 1% by weight of such auxiliaries based on the sum of the polymers present.

Applications of these shaped articles are apparent both in rapid prototyping and in rapid manufacturing. The latter particularly includes small runs, i.e. the production of more more than one identical part, where production using an injection mold is, however, uneconomic. Examples include parts for high-end passenger cars produced only in small numbers or replacement parts for motorsport where not only the small numbers but also the time of availability are important. Industries in which the parts are used can include aerospace, medical engineering, mechanical engineering, automaking, sports, household goods, electricals and lifestyle.

The following examples shall describe the powder according to the invention and the use thereof, without limiting the invention to the examples. The measured values of poured density were determined with an apparatus according to DIN EN ISO 60.

### EXAMPLES

### Comparative Example 1: Reprecipitation of Nylon-12 (PA 12)

348 kg of balanced PA 12 produced by hydrolytic polymerization and having a relative solution viscosity of 1.62 and an end group content of 75 mmol/kg COOH or 69 mmol/kg NH₂ were brought to 145° C. together with 2500 l of ethanol denatured with 2-butanone and with a water content 1% in a 3 m3 stirred tank (a=160 cm) over 5 hours and held at this temperature for 1 hour with stirring (blade stirrer, x=80 cm, speed=49 rpm). The jacket temperature is then reduced to 124° C. and with continuous distillative removal of the ethanol the internal temperature is brought to 125° C. at a cooling rate of 25 K/h at the same stirrer speed. From this point on the jacket temperature was kept 2 K-3 K below the internal temperature at the same cooling rate. The internal temperature is brought to 117° C. at the same cooling rate and then kept constant for 60 minutes. Distillative removal was continued at a cooling rate of 40 K/h and the internal temperature thus brought to 111° C. Onset of precipitation, detectable through evolutions of heat, occurs at this temperature. The distillation rate is increased such that the internal temperature does not exceed 111.3° C. After 25 minutes, the internal temperature falls, thus indicating the end of the precipitation. Through further distillative removal and cooling via the jacket the temperature of the suspension is brought to 45° C. and the suspension subsequently transferred into a paddle dryer. The ethanol is distilled off at 70° C./400 mbar and then the residue is subjected to further drying at 20 mbar/86° C. for 3 hours.

A carbon black (Orion PRINTEX 60) is incorporated by dry blend methods using a Henschel P10 mixer at 400 rpm for 5 minutes. This affords a powder as summarized in table 1.

TABLE 1
Noninventive powder

| | | | | | | | |
|---|---|---|---|---|---|---|---|
| SSpd | EtOH | PA | Particles | PD | D50 | BET | Colour |
| rpm | I | kg | kg (%) | g/l | μm | m²/g | number L* |

Printex60

| | | | | | | | |
|---|---|---|---|---|---|---|---|
| 40 | 2500 | 348 | 0.697 | 438 | 55 | 8 | 42.6 |
| | | | (0.2) | | | | |
| 40 | 2500 | 348 | 7.1 (2) | 347 | 55 | 8 | 19.8 |

The L* value (CIEL*a*b*) was carried out according to DIN EN ISO/CIE 11664-4 with an x-rite Color i7 spectrophotometer.

### Example 2: Single-Step Reprecipitation of PA12 with Core Particles (Inventive)

According to example 1 a PA12 produced by hydrolytic polymerization having a relative solution viscosity (ηᵣₑₗ) of 1.62 and an end group content of 75 mmol/kg COOH or 66 mmol/kg NH2 was reprecipitated in the presence of 162.5-250 kg of particles having the characteristics shown in table 2.

TABLE 2
Characteristics of the various core particles used in example 2

| | Average primary |
|---|---|
| | particle size (nm) |
| Particles | ASTM D 3849 |
| Orion PRINTEX 60 | 21 |
| Orion PRINTEX 80 | 16 |

In this example the precipitation conditions were altered relative to example 1 as follows:
Precipitation temperature: 108° C.
Precipitation time: 150 min
Stirrer speed: 39 to 82 rpm

The characteristics (poured density, diameter and BET surface area) of the powders produced according to example 2 are summarized in table 3. Table 3 also indicates the employed amounts of polyamide, core particles and ethanol and the stirrer speed used in the process.

TABLE 3
Powder according to the invention

| | | | | | | | |
|---|---|---|---|---|---|---|---|
| SSpd | EtOH | PA | Particles | PD | D50 | BET | Colour |
| rpm | I | kg | kg (%) | g/l | μm | m²/g | number L* |

Printex60

| | | | | | | | |
|---|---|---|---|---|---|---|---|
| 40 | 2500 | 348 | 0.697 (0.2) | 406 | 55 | 11 | 73.4 |
| 40 | 2500 | 348 | 1.047 (0.3) | 425 | 56 | 6 | 70.4 |
| 40 | 2500 | 348 | 7.1 (2) | 427 | 56 | 20 | 57.2 |

The inventive example 2 shows that a composite particle has been produced, wherein the carbon black (NIR- and/or VIS-absorbing component) is arranged inside the core. This is indicated by the L* value in the CIEL*a*b*color space. Although the ratio of carbon black to the polymer of the composite particle in example 2 is identical compared to comparative example 1, the L* value is markedly higher. Accordingly the carbon black is inside the composite particle, i.e. in the core of the particle. The NIR and/or VIS absorbing component inside the particle makes it possible to ensure uniform melting of a powder and thus reduce a tendency for warpage of the component to be produced. A high L* value of the composite particle allows the powder/the resulting shaped article to be dyed.

1. A powder for use in a layerwise process for producing shaped articles in which regions of the respective powder layer are selectively melted by introduction of electromagnetic energy, the powder comprising:
composite particles which are entirely or partially comprising core particles coated with a precipitated first polymer, wherein the core particles comprise an NIR-absorbing (near infrared-absorbing) component.

2. The powder according to claim 1, wherein the NIR-absorbing component has an absorption of at least 40% at all wavelengths in a range from 780 to 1500 nm.

3. The powder according to claim 1, wherein the NIR-absorbing component has an absorption of at least 40% at all wavelengths in a range from 380 to 1500 nm.

4. The powder according to claim 1, wherein the NIR-absorbing component comprises carbon black and/or TiO₂.

5. The powder according to claim 1, wherein the NIR-absorbing component has an L* (according to CIEL*a*b*, DIN EN ISO/CIE 11664-4) of not more than 10, and/or
wherein the composite particles have an L* (according to CIEL*a*b*, DIN EN ISO/CIE 11664-4) of above 20.

6. The powder according to claim 1, wherein the NIR-absorbing component is present in an amount of 0.01% to 7% by weight based on the total weight of the composite particle.

7. The powder according to claim 1, wherein the NIR-absorbing component is present in an amount of 1% to 100% by weight based on the total weight of the core particle.

8. The powder according to claim 1, wherein the core particles have an average particle diameter dv50 of 1 μm or more, and/or
wherein the composite particles have an average particle diameter d50 of 20 to 150 μm.

9. The powder according to claim 1, wherein the core particles comprise a second polymer, and wherein the second polymer is different from the first polymer or the first and the second polymer are the same polymers.

10. The powder according to claim 1, wherein (A) the precipitated first polymer is selected from the group consisting of polyolefin, polyethylene, polypropylene, polyvinyl chloride, polyacetal, polystyrene, polyimide, polysulfone, poly(N-methyl methacrylimide) (PMMI), polymethyl methacrylate (PMMA), polyvinylidene fluoride (PVDF), ionomer, polyether ketone, polyaryl ether ketone, polyamide, copolyamide and mixtures thereof, and/or
(B) the second polymer is selected from the group consisting of polycarbonate, polymethyl methacrylate, polypropylene, polybutylene terephthalate, polyethylene terephthalate, polyether ether ketone, polyphthalamide and mixtures thereof.

11. The powder according to claim 1, wherein a proportion of the composite particles in the powder is at least 50% by weight.

12. A process for producing the powder according to claim 1, comprising:
in order to produce an at least partial solution, bringing a polymer into contact with a medium comprising solvent capable of dissolving the first polymer in the presence of core particles under elevated pressure and/or temperature, and
subsequently precipitating the first polymer out of the at least partial solution to obtain composite particles comprising core particles completely or partially coated with a precipitated first polymer, wherein the core particles contain an NIR-absorbing component.

13. A process for producing a shaped article by a layerwise process, comprising:
selectively melting regions of a powder layer through introduction of electromagnetic energy, wherein the powder according to claim 1 is used, wherein a wavelength of the electromagnetic energy is in a near-infrared range in a wavelength range of 780 to 1500 nm.

14. The process according to claim 13,
wherein the powder is uniformly melted and/or reduces the tendency for warpage of the component to be produced.

15. A shaped article obtained by the process according to claim 13.

16. The powder according to claim 2, wherein the NIR-absorbing component has an absorption of at least 60% at all wavelengths in the range from 780 to 1500 nm.

17. The powder according to claim 3, wherein the NIR-absorbing component has an absorption of at least 60% at all wavelengths in the range from 380 to 1500 nm.

18. The powder according to claim 5, wherein the NIR-absorbing component has an L* of not more than 3, and/or wherein the composite particles have an L* of above 50.

19. The powder according to claim 6, wherein the NIR-absorbing component is present in an amount of 0.2% to 2% by weight based on the total weight of the composite particle.

20. The powder according to claim 7, wherein the NIR-absorbing component is present in an amount of 100% by weight based on the total weight of the core particle.
